(19) United States
(12) Patent Application Publication
(10) Pub. No.: US 2025/0175798 A1
(43) Pub. Date: May 29, 2025

(54) AUTHORIZATION OF EXTERNAL APPLICATION FUNCTIONS TO MOBILE NETWORK SERVICES

(71) Applicant: Nokia Technologies Oy, Espoo (FI)

(72) Inventors: Peter ROST, Heidelberg (DE); Markus STAUFER, Munich (DE)

(73) Assignee: Nokia Technologies Oy, Espoo (FI)

(21) Appl. No.: 18/839,847

(22) PCT Filed: Feb. 8, 2023
(86) PCT No.: PCT/FI2023/050077

§ 371 Date: Aug. 20, 2024

(30) Foreign Application Priority Data
Feb. 21, 2022 (FI) 20225152

(51) Int. Cl. H04W 12/084; H04L 9/32; H04W 12/72

(52) U.S. Cl. CPC H04W 12/084; H04L 9/3213; H04W 12/72; H04L 2209/80

(57) ABSTRACT

According to an example aspect of the present invention, there is provided a method, comprising: obtaining (200) client credentials associated with a subscriber identity module of a user equipment, sending (210), to an authorization function, an access token request for an access token to authorize, for an application function outside a mobile network, access to a network exposure function of the mobile network, wherein the access token request comprises the client credentials, receiving (220) the access token issued by the authorization function, and sending (230) an access request to the network exposure function to access a service of the mobile network via the network exposure function, wherein the access request comprises the received access token.

### FIELD

Various example embodiments relate in general to authorizing access to mobile network services for external application functions and more specifically, authorizing access to a network exposure function for an application function outside a mobile network.

### BACKGROUND

Industrial networks may comprise various devices, such as smart sensors, actuators, connected via an industrial network. Such devices are widely referred to as internet of things (IoT) devices. Industrial networks are often referred to as industrial automation networks, such as Industrial IoT (IIoT) or Industry 4.0 networks. Mobile connectivity, which may generally refer to wireless access via a wireless network, may be used in industrial networks to provide flexibility (in terms of mobility) and scalability (in terms of number of sensors or actuators, for example). Industrial controllers, such as programmable logic controllers (PLC) or programmable controllers, are used to control an industrial process or a portion thereof, such as assembly line(s), machines, or robotic device(s). In addition to control on a field level, a PLC may provide a management and control interface using a Human-Machine-Interface (HMI) or towards a Supervisory Control and Data Acquisition (SCADA) system. With the increasing flexibility of industrial automation, a PLC may be wirelessly connected, for example on a movable or mobile machine, such as an automatically guided vehicle (AGV) of a factory.

### SUMMARY

Some aspects of the invention are defined by the features of the independent claims. Some specific embodiments are defined in the dependent claims.

According to a first aspect, there is provided a method, comprising: obtaining client credentials associated with a subscriber identity module of a user equipment, sending, to an authorization function, an access token request for an access token to authorize, for an application function outside a mobile network, access to a network exposure function of the mobile network, wherein the access token request comprises the client credentials, receiving the access token issued by the authorization function, and sending an access request to the network exposure function to access a service of the mobile network via the network exposure function, wherein the access request comprises the received access token.

According to a second aspect, there is provided a method, comprising: receiving, by an authorization function, an access token request for an access token to authorize, for an application function outside a mobile network, access to a network exposure function of the mobile network, wherein the access token request comprises client credentials associated with a subscriber identity module of a user equipment, authorizing the access for the application function and generating the access token in response to verification of the client credentials, and sending the access token to authorize the access to the network exposure function for the application function.

In an embodiment of the first aspect or an embodiment thereof, the apparatus performing the method is further configured to authenticate the authorization function and the network exposure function by at least one certificate authority certificate.

In an embodiment of the second aspect or an embodiment thereof, the apparatus is configured to send an application key request to an authentication and key management for applications, AKMA, anchor function. The apparatus may receive a reference application key computed by the AKMA anchor and verify the client credentials on the basis of comparing the application key in the received client credentials to the reference application key. The application key request may comprise the application key identifier and an application identifier, which are used to generate the reference application key. The application identifier may be based on a FQDN of the authorization function and a protocol identifier of a security protocol between the application function and the authorization function.

In an embodiment of the first or the second aspect or an embodiment thereof, credentials are associated with the subscriber identity module by the subscriber identity module storing at least one portion of the client credentials or a cryptographic key on the basis of which at least one portion of the client credentials is generated.

In an embodiment of the first aspect or the second aspect or an embodiment thereof, the client credentials comprise an application key and an application key identifier based on an intermediate key based on an authentication and key agreement procedure of the user equipment with the mobile network.

In an embodiment of the first or the second aspect or an embodiment thereof, the access token request comprises a FQDN of the authorization function and the access request comprises a FQDN of the network exposure function.

In an embodiment of the first or second aspect or an embodiment thereof, the requested access, and the access token, is for accessing and/or controlling a mobile connectivity configuration.

In an embodiment of the first or second aspect or an embodiment thereof, the subscriber identity module is comprised by a physical or embedded integrated circuit card of the user equipment included in or connected by a communications device comprising the application function. Some further embodiments of the first and/or the second aspect are illustrated in the dependent apparatus claims.

There is also provided an apparatus comprising at least one processor, at least one memory including computer program code, the at least one memory and the computer program code being configured to, with the at least one processor, cause the apparatus at least to carry out features in accordance with the first and/or second aspect, or any embodiment thereof.

There is further provided an apparatus, comprising means configured for causing the apparatus at least to carry out features in accordance with the first and/or second aspect, or any embodiment thereof. The means may comprise at least one processor, and at least one memory including computer program code, the at least one memory and the computer program code being configured to, with the at least one processor, cause the performance of the apparatus. The apparatus caused to perform the first aspect may be a user equipment or comprised in a user equipment or device. The apparatus caused to perform the second aspect may be a network node or device or comprised in a network node or device.

According to still further aspects, there is provided a computer program, a computer-readable medium, or a non-transitory computer-readable medium, which may comprise code configured for, when executed in a data processing apparatus, causing the apparatus to perform features in accordance with the first and/or second aspect, or an embodiment thereof.

### BRIEF DESCRIPTION OF THE DRAWINGS

FIG. 1 illustrates an example wireless communication system;

FIGS. 2 and 3 illustrate methods in accordance with at least some

embodiments;

FIG. 4 illustrates an example configuration of an industrial communications device;

FIGS. 5 and 6 illustrate signalling examples;

FIG. 7 illustrates cryptographic key hierarchy in accordance with at least some embodiments;

FIGS. 8 and 9 illustrate signalling examples; and

FIG. 10 illustrates an example apparatus capable of supporting at least some embodiments.

### EMBODIMENTS

A network exposure function may be a functional element that supports secure external exposure of services provided by a mobile network, such as a 5^{th} generation mobile communications network. For example, an application function of a communications device of an industrial network may be connected to a network exposure function to provide connectivity configuration information to the mobile network. Access to mobile network via a network exposure function requires authorization of the external application function. An example of the industrial network may be non-public network a non-public network (NPN, also sometimes called a private network) providing 5G network services to a clearly defined user organisation or group of organisations. Communication systems employed in applications like vertical industries are for fulfilling certain requirements, such as high communication service availability and low end-to-end latency. In order to provide such capabilities, mechanisms for Time Sensitive Networking (TSN) as defined by IEEE are integrated with 5GS. TSN is currently standardized as the mechanism for communication within industrial networks. A set of IEEE 802.1 protocols (IEEE 802.1AS-Rev, 802.1CB, 802.1Qcc, 802.1Qch, 802.1Qci, 802.1Qcj, 802.1 CM, 802.1Qcp, 802.1Qcr, 802.1AB) is applied to achieve deterministic data transmission, for example.

New communication systems, such as the 5G System (5GS), are developed in order to support new business models such as those for IIoT and enterprise managed networks. Services such as unmanned aerial vehicle control, augmented reality, and factory automation are intended to be provided. Network flexibility enhancements support self-contained enterprise networks, installed and maintained by network operators while being managed by the enterprise. Enhanced connection modes and evolved security facilitate support of massive IIoT, expected to include tens of millions of UEs sending and receiving data over the 5G network, for example.

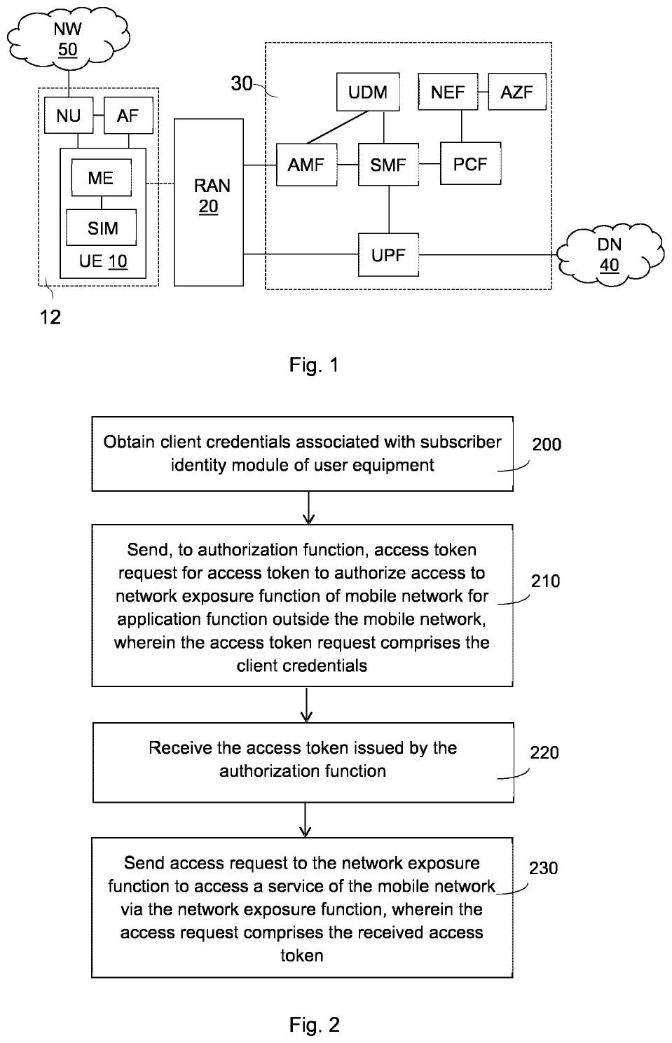

FIG. 1 illustrates a simplified example communications system. A mobile communication device, herein referred to as user equipment (UE) 10 communicates wirelessly with an access device of a radio access network (RAN) 20. Such device or node of the RAN 20 may be a NodeB, an evolved NodeB (CNB), a Next Generation (NG) NodeB (gNB), a base station, an access point, or other suitable wireless/radio access network device. The air interface between the UE 10 and the RAN 20 may be configured in accordance with a Radio Access Technology, RAT, which both the UE 10 and RAN access device are configured to support. Examples of cellular RATs include Long Term Evolution, LTE, New Radio, NR, which is also known as fifth generation, 5G, and MulteFire. Principles of the present disclosure are not limited to a specific RAT though.

The RAN 20 is connected to a core network (CN) 30, such as a Next Generation CN, Evolved Packet Core (EPC), or 6G CN. The CN 30 may comprise a set of network functions. A network function (NF) may refer to an operational and/or physical entity. The network function may be a specific network node or clement, or a specific function or set of functions carried out by one or more entities, such as virtual network elements. Examples of such network functions include an access control or management function, mobility management or control function, session management or control function, interworking, data management or storage function, authentication function or a combination of one or more of these functions.

Some 5G core network functions are illustrated in FIG. 1. A Third Generation Partnership Project (3GPP) 5G CN comprises Access and Mobility Management Function (AMF) which may be configured to terminate RAN control plane (N2) interface and perform registration management, connection management, reachability management, mobility management, access authentication, access authorization, Security Anchor Functionality (SEAF), Security Context Management (SCM), and support for interface for non-3GPP access.

User Plane Function (UPF) performs i.a. packet inspection, routing and forwarding and operates as external packet data unit (PDU) session point to interconnect external data networks 40. Session Management Function (SMF) is responsible i.a. for session establishment, modify and release. Policy Control function (PCF) supports policy framework to govern network behavior, provides policy rules to control plane functions, and accesses subscription information relevant for policy decisions in a Unified Data Repository (UDR).

Subscriber authorization, registration and mobility management are supported by the Unified Data Management (UDM) and Authentication Server Function (AUSF). UDM i.a. comprises Authentication credential Repository and Processing Function (APRF), which is a functional element responsible for 5G authentication vectors based on subscriber's shared secret key.

Network exposure function (NEF) is a functional element that supports secure external exposure of capabilities and events provided by 3GPP NF(s) to external AF(s), which interact with relevant network function(s) via the NEF. The NEF may be configured to support expose of information (collected from other 3GPP NFs) to the AF.

The NEF is configured to provide secure provision of information from external AFs to 3GPP network. An AF can get services from multiple NEFs, and an NEF can provide services to multiple AFs. Such information may include expected UE behavior time synchronization service information and service specific information, for example. The NEF may be configured to translate information exchanged with the external AF and information exchanged with an internal NF. The NEF may be configured to handle masking of network and user sensitive information to external AF's according to the network policy.

The NEF may be configured to support a packet flow description (PFD) function. The PFD Function in the NEF may store and retrieve PFD(s) in the UDR and provide PFD(s) to the SMF on the request of SMF (pull mode) or on the request of PFD management from NEF (push mode). A specific NEF instance may support one or more of the functionalities described above and consequently an individual NEF may support a subset of the APIs specified for capability exposure.

The CN 30 may be coupled to a further packet data network 40, via which connectivity to further networks may be obtained, for example via a worldwide interconnection network.

The UE 10 may be referred to as a user device or wireless terminal in general. Hence, without limiting to the User Equipment of 3GPP systems, the term user equipment or UE is to be understood broadly to cover various mobile/wireless terminal devices, mobile stations and user devices for user communication and/or machine to machine type communication. The UE 10 may be or be comprised by, for example, a smartphone, a cellular phone, a Machine-to-Machine, M2M, node, machine-type communications node, an Internet of Things, IoT, node, a car telemetry unit, a laptop computer, a tablet computer or, another kind of suitable user device or mobile station, i.e., a terminal.

The system may be able to support usage of cloud services, for example some of CN operations may be carried out as a cloud service. The communication system may also comprise a central control entity, or a like, providing facilities for networks of different operators to cooperate for example in spectrum sharing. Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. One of the concepts for 5G networks is network slicing in which multiple independent and dedicated virtual sub-networks (network instances) may be created within the same infrastructure to run services that have different requirements on latency, reliability, throughput and mobility.

The person skilled in the art will realize that the depicted system is only an example of a part of a system and in practice, the system may comprise further access nodes, the user device may have an access to a plurality of radio cells and the system may comprise also other apparatuses, such as physical layer relay nodes or other CN functions or elements, etc. Additionally, although the apparatuses have been depicted as single entities, it will be appreciated that different units, processors and/or memory units (not shown in FIG. 1) may be implemented inside these apparatuses, to enable the functioning thereof.

As further illustrated in the example of FIG. 1, the UE 10 may be comprised by a communications device 12 comprising an application function (AF) external of the mobile communications network comprising the RAN 20 and the CN 30. The communications device 12 may comprise a further networking unit or interface (NU) to connect with a further communications network 50. In some embodiments, the network 50 is an industrial network and the device 12 is an industrial network communications device, such as a device configured to operate as an industrial controller. An example of such industrial controller is a PLC connected to and controlling a set of field devices.

The AF may be configured to interact with the CN 30 via the NEF in order to access network capabilities. For example, if a PLC is connected through a mobile network as well as its connected devices, the PLC may need to provide connectivity configuration information to the mobile network. For example, in case of 3GPP 5G system, the PLC may be configured to access a 5G CN NEF API to provide the connectivity configuration.

The NEF may be associated with an authorization function (AZF). The AZF may be accessed by the AF to retrieve information, such as an access token, which can be included in AF's requests to the NEF and which can be used by the NEF to authorize the request.

A dedicated key may be required for the AF in order to be authenticated and authorized, and eventually to access the NEF. This key may be provided through a non-3GPP function which provides the key to both, AF and an AZF associated with the NEF. However, the key distribution and management may become error prone and requires additional software/hardware at the PLC to make sure that those keys are not misused.

There is now provided a solution for authorizing access for an AF outside a mobile network to a NEF, based on utilizing a subscriber identity module, hereafter referred as SIM, used for accessing the mobile network.

FIG. 2 illustrates a method for requesting access to a network exposure function of a mobile network. The method may be performed or caused by an apparatus, also referred to as requesting apparatus, comprising or connected to an application function outside the mobile network. The application function is hereafter referred as AF, without limiting to the AF as illustrated in FIG. 1 or AF of 3GPP 5G systems. Such apparatus may be a communications apparatus or device, such as the UE 10 or the device 12 comprising the UE 10 and/or AF 12, or a controller thereof.

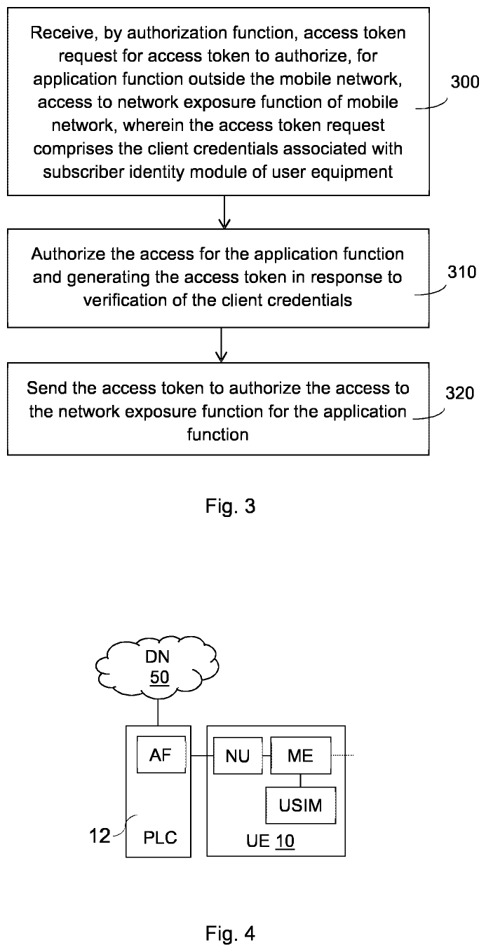

Block 200 comprises obtaining client credentials associated with a SIM of a user equipment. The user equipment is below also referred to as UE, without limiting to the UE as illustrated in FIG. 1 or 3GPP User Equipment.

Block 210 comprises sending, to an authorization function, an access token request for an access token to authorize, for an AF outside a mobile network, access to a network exposure function of the mobile network. The access token request comprises the client credentials. The authorization function is below also referred to as AZF and the network exposure function as NEF.

Block 220 comprises receiving the access token issued by the AZF. As also indicated by block 320 of FIG. 3, the AZF transmits the access token in response to verification of the client credentials by the AZF.

Block 230 comprises sending an access request to the NEF to access a service of the mobile network via the NEF. The access request comprises the received access token.

FIG. 3 illustrates a method for controlling AZF. The method may be performed or caused by an apparatus, such as network node, entity, server or device configured to perform the AZF, such as an OAuth server, or a controller thereof.

Block 300 comprises receiving, by an AZF, an access token request for an access token to authorize, for an AF outside a mobile network, access to an NEF of the mobile network. The access token request comprises client credentials associated with a SIM of a UE.

Block 310 comprises authorizing the access for the AF and generating the access token in response to successful verification of the client credentials.

Block 320 comprises sending the access token to authorize the access to the NEF for the AF.

The client credentials may be obtained at block 200 by receiving some or all of the client credentials from another module, function or memory and/or by defining some or all of the client credentials based on information associated with the SIM. For example, the client credentials may comprise: a client secret associated with a client identifier, a signed certificate, such as a X.509 certificate, or a client assertion, such as a javascript object notation web token, computed based on a client secret. The association of the client credentials with the SIM may refer to storing in the SIM at least one parameter or key to generate a client secret included in the client credentials, or storing at least some portion of the client credentials in the SIM. There are many alternative examples for associating the client credentials with the SIM, some embodiments being further illustrated below. The client credentials may be associated with the SIM, for example, by the SIM storing at least one portion of the client credentials or by using a cryptographic key on the basis of which at least one portion of the client credentials is generated. The at least one portion of the client credentials may be a client secret, which is included in the access token request to authenticate the AF (having access to the SIM or being represented by the SIM).

The verification of the client credentials may refer to successfully verifying an authentication token of the client credentials, such as a client secret based on or received from the SIM. The verification may be performed in block 310 or as separate block after block 300. Successful verification may be an authentication precondition for entering block 310. The client credentials and the verification may comprise also further information, such as a client identifier (id) or signature. Thus, the entity performing the method of FIG. 2 and transmitting the access token request may be authenticated based on SIM based credentials. If the client credentials cannot be verified, block 320 is not entered but a response message indicative of rejection of the access token request may be transmitted. Authentication between AF, connected to or otherwise associated with the UE, and AZF can be executed using existing SIM credentials, and existence or distribution of other credentials can be avoided.

The network exposure function or NEF, may refer generally to a network function enabling provision of information to and/or from the mobile network for external AFs outside the mobile network. The term network exposure function or NEF is thus not limited to the 3GPP NEF or the NEF as illustrated in FIG. 1. The application function or AF, outside the mobile network, may refer to an application entity, such as a third-party application or an industrial network service or service application, outside CN of a mobile communications network, such as 3GPP CN. The authorization function or AZF may refer to an authorizing network entity configured to authorize access at least of external AF(s) to a NEF. The AZF may refer to an authorization server, such as an OAuth Authorization Server of a 5G network communicating with an OAuth client of the apparatus 12 performing the method of FIG. 2. Instead of OAuth-based authorization, security assertion markup language (SAML)-based authorization may be applied, for example. The AF is thus not limited to 3GPP AFs and the AZF is not limited to 3GPP network authorization function or server, such as the NEF adapted to authorize 5G NFs. The access token request may be sent from the AF (on the device) to the AZF or from the cellular module to the AZF.

The term subscriber identity module or SIM may generally refer to an operational module representative of a subscription and a subscriber in a mobile communications network, such as the USIM in a 3GPP 5G network, without however limiting to such SIMs or networks. The SIM may be comprised by a physical or embedded integrated circuit card of the UE included in or connected by a communications device comprising the AF. In another embodiment, another element hosting the subscriber profile may also implement the SIM related functionality applied for generating the client credentials, some further example embodiments being illustrated below. The SIM may be deployed to the communications device by remote SIM provisioning. At least some portion of client credentials or at least one secret to generate the client credentials may thus be comprised by a SIM profile, which may be provisioned to the communications device.

The access authorization may be requested in block 300 and issued in block 310 to permit the AF transmitting information to the mobile network via the NEF, and/or to permit the AF to receive information from the mobile network via the NEF. However, the service requested in block 230 may be any service of the mobile network that is provided for exposure for external AFs via the NEF, such as 3GPP 5G CN services and capabilities allowed for exposure via the 5G NEF API. The access request may be for requesting authorization of access to control a mobile connectivity configuration, without however limiting to such purpose. The access token may thus be generated and transmitted to the requesting device in response to the AZF authorizing the AF to control the mobile connectivity configuration.

The apparatus performing the method of FIG. 2 may be configured to perform the AF. The AF may be configured to send 230 the access request. The AF may thus send a request for client credentials to the SIM or to the UE comprising the SIM. In the latter case, the UE may generate the client credentials upon the request or retrieve the credentials (or at least a portion thereof) from the SIM. The UE may then provide the generated or retrieved client credentials to the AF (which may reside in the same communications device 12). The request may be a command to retrieve the respective information. The AF receives the client credentials from the UE or the SIM and includes the received client credentials in the access token request of block 210.

In another embodiment, the AF, configured to send 230 the access request, is further configured to send a request for an access token to the UE comprising the SIM. The AF receives the access token from the UE after the UE has sent the access token request and received the access token on behalf of the AF.

The UE may comprise a cellular module, such as a module configured to perform the ME configured to access the SIM included in or connectable by the module. Interactions with the SIM and the AF may thus be encapsulated in the cellular module, providing the additional benefit that the developer of an AF does not need to take care about the details of interacting with a SIM or the AZF.

The cellular module may receive a request for an access token from the AF. The cellular module may be configured to:
in response to the request for an access token, retrieve at least a portion of the client credentials from the SIM or generate at least a portion of the client credentials,
send the access token request comprising the client credentials to the AZF (on behalf of the AF),
receive the access token from the AZF in response to verification of the client credentials by the AZF, and
provide the access token to the AF. The AF may then include the access token received from the cellular module in the access request of bloc 230 to the NEF.

Depending on the applied embodiment, the AZF may thus receive 300 the access token request from the AF, from the UE, or the cellular module sending the access token request on behalf of the AF. The AZF may thus send the access token in block 320 in an access token response to the AF, the UE, or the cellular module in response to successfully verifying the client credentials.

The apparatus performing the method of FIG. 2 may be further configured to authenticate the AZF and the NEF by at least one certificate authority certificate. Successful authentication may be a precondition for trusting the AZF and proceeding with the authorization and access request to the NEF. The certificate may be received from the SIM, for example.

The device 12 comprising the UE 10 and/or the AF may be a communications device of an industrial network, such as Industrial IoT (IIoT) device, a time-sensitive networking (TSN) network device, or a Profinet device. The device comprising the UE and/or AF may be configured to operate as an industrial controller, such as a PLC. The device 12 of FIG. 1 may thus comprise a PLC. The device comprising the AF may be configured to operate as an industrial network controller (INC). For example, the INC may use the NEF, such as a 5G CN NEF API, to configure properties of the industrial network. The NEF may be configured to limit access granted to the AF using information in the access token received in the access request of block 230. The NEF may be configured to use information retrieved from other NFs of the CN 30.

A PLC may comprise an offline designed connectivity layout, i.e., a predefined configuration on the devices supposed to be connected to the PLC. Based on such a layout, as well as network information, the PLC may set up end-to-end connectivity. For example, the PLC may be configured to operate as a centralized user configuration (CUC) instance in a TSN network towards a centralized network configuration (CNC) instance, which is using the AF part of the UE and the NEF to configure TSN traffic streams in the industrial 5G network. In a Profinet deployment, a separate Layer 7 Profinet protocol may be used to configure both devices and network equipment.

Example embodiments of the methods can be related to 3GPP 5G SBA related enhancements, some of which are further illustrated below. Though, it is noted that any references below to 3GPP 5G SBA, in this application are used as examples to describe some example embodiments, and other technologies can also be applied.

The UE 10 may be a 3GPP 5G UE comprising an ME and a USIM (as the SIM e.g. in the example of FIG. 1). The ME comprises a NR transceiver configured to access NG RAN, for example. The AF outside a 5G network may thus obtain, based on USIM based credentials and verification, an access token from the AZF to access 5G services exposed by the 5G CN via the NEF.

The USIM may be comprised in an universal integrated circuit card (UICC), an embedded UICC (eUICC) or an integrated UICC (iUICC) of the UE 10 included in or connected by the communications device 12 comprising the AF. The AF may be provided with fully qualified domain name (FQDN) of the AZF and the NEF. FQDNs can be derived from aPLMN identifier, and in case of a stand-alone public network (SNPN) additionally from a network identifier (NID). Alternatively, the FQDNs may be stored as part of the USIM.

The interface between the AF and the NEF may be the NEF Northbound (Nnef) interface. The Nnef interface specifies RESTful/RPC APIs that allow the AF to access the services and capabilities provided by 3GPP network entities and securely exposed by the NEF, and is further defined in 3GPP TS 29.522. The apparatus performing the method of FIG. 2, such as the device 12, may be configured to support at least some of the procedures specified for the Nnef interface, and access services exposed for external AFs via the Nnef interface.

Transport layer security (TLS), specified by IETF RFC 5246, may be used to secure the communication between the NEF and the AF over the Nnef interface. The access to service capability exposure function (SCEF) northbound APIs may be authorized based on OAuth2 protocol specified in IETF RFC 6749, for example and SCEF of 4G as an example. SCEF having at least part of functions of NEF. The authorization may be based on local configuration, using client credentials authorization grant.

A device, such as the device 12, comprising the 5G UE and/or AF and utilizing the 5G CN NEF API access may be configured to operate as an industrial controller, such as a PLC. For example, the AF is an INC and the device comprising the 5G UE comprises or is an industrial controller, such as a PLC. The INC may be configured to use the NEF API to configure properties of a connected industrial network. The access request may be sent at 230 in FIG. 2 to control a mobile connectivity configuration of the industrial network. For example, the PLC may determine quality of service (QOS) requirements to the 5G network via the NEF API, such as minimum delay and/or priority. The PLC may be configured to configure, via the NEF API, traffic pattern information using time sensitive communication assistance information (TSCAI).

As a further example, the device comprising the 5G UE and/or AF and utilizing the 5G CN NEF API access may be configured to obtain location information via the 5G CN NEF for itself or for other industrial devices comprising 5G UEs and to make use of the location information, for instance in an automation scenario.

FIG. 4 illustrates an example of an industrial communications device arrangement in which the device 12 is a PLC device comprising the AF. Differing from the example of FIG. 1, the device 12 comprising the AF is now connected to the UE 10 comprising or connected to an NU, such as an Ethernet network card, to communicate with the device 12. The UE 10 in this example is a 5G UE comprising a USIM. The ME (which may operate as the cellular module) and the USIM may operate as disclosed in the present example embodiments, to provide USIM-based client credentials to authorize the AF to access the NEF API.

The NEF API may be configured to limit the access granted to the AF using information in the received access token. The NEF API may also limit the access using information retrieved from other NFs of the 5G CN, for instance from the PCF. For example, the authorized AF may be allowed to request connectivity information of devices being member of the same virtual network group, or the same network slice, or another pre-defined group (representing for instance an industrial network or defined subset of an industrial network). The authorized AF may be allowed to change connection parameters of devices being member of the same VN group, or the same network slice, or another pre-defined group. In certain embodiments only certain predefined UE(s) out of a VN group may be allowed to request connectivity information or modify connection parameters using the AF associated with the UE.

In an example, now disclosed with reference to 5G system, without limitation of the disclosed embodiments thereto, the USIM is configured to store at least a portion of the client credentials as new parameters. The apparatus performing the method of FIG. 2 is configured to receive the at least a portion of the client credentials directly or indirectly from the USIM.

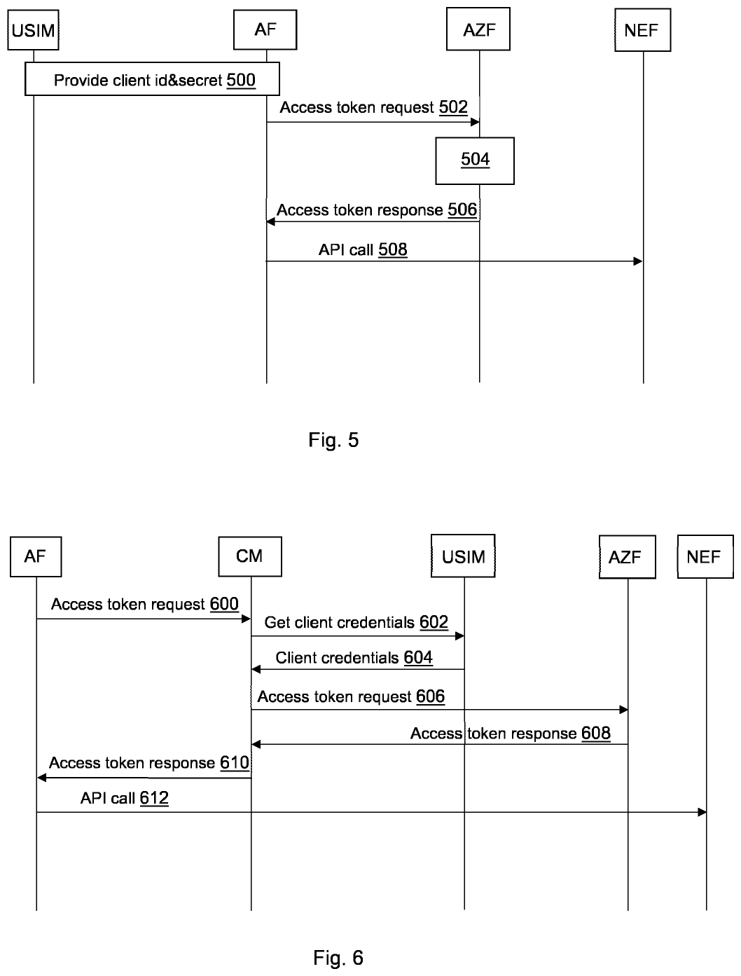

As illustrated in the signaling example of FIG. 5, the AF may directly receive 500, from the USIM, client id and client secret which are preprovisioned on the USIM. The AF, which may operate as OAuth client, may then send in block 210 an access token request 502 to the AZF which may operate as OAuth server. The access token request comprises the received client id and client secret. In an example embodiment, the AF applies the client id and the client secret (from the USIM) for http basic authentication with the AZF. In addition, the AF may provide parameters, such as requested scopes, as input to the access token request.

The AZF may also be preprovisioned with information, which allows the AZF to verify the client id and the client secret in block 310. This information may include the client id and the client secret, that is, USIM and AZF are in possession of a preshared key. If the client id and the client secret received from the AF are successfully verified at 504, the AZF may send a token response at 506 comprising the access token. The AF may then send an API call at 508, comprising the access token, to the NEF API as the access request to access an exposed service of the associated 5G SBA CN.

An advantage of the example embodiment above is that it can be applied independent from the 5G primary authentication. Thus, it can also be used when the apparatus performing the method of FIG. 2, such as the device 12, is not connected to the 5G system.

The AF may request or retrieve the client id and the client secret using an extension of an interface between host part of the device and the cellular module. This can be achieved by introducing a new AT+ command or extending another interface which is used instead of AT+ commands.

The same client id and the client secret, which are stored on the USIM, may be provisioned on the AZF as part of the USIM lifecycle management process. For example, the client id and the client secret may be provisioned into the UICC as part of the UICC manufacturing process and provided to the mobile network operator as part of a personalization file, which may include also other personalization data (intended for provisioning into UDM/UDR). The client id and the client secret may be used together with associated generic public subscription information (GPSI) to register the client at the AZF. The AZF may hold a mapping table between client id and the client secret and can in this way restrict any claims in the issued access token to the level of authority of the UE (identified by GPSI). In another embodiment, GPSI can also be used as the client id.

The USIM may be deployed to the device 12 as part of a remote SIM provisioning procedure. In this case, the client id and client secret are part of the SIM profile, which is provisioned to the device. The mobile operator does not retrieve the client id and client secret from the SIM manufacturer, but as part of the profile management process executed with the provisioning server.

In another embodiment, information and functionality related to client id and client secret, client assertions, or (as the client credentials) may be installed or updated on the UE 10 using (over-the-air) OTA SIM technology or another technology used to update the content of a USIM. The installation and/or update may include the client id and client secret, or certificates. The installation and/or update may comprise computer code, such as code causing an executing processor to calculate client assertions and/or to expose client X.509 certificates.

The USIM may provide a command, which can be used by the AF to receive a client assertion from the USIM. For example, the client assertion may be a JSON web token (JWT), which can be used by the AZF to verify the identity of the client.

The AF can trigger the calculation of the client assertion and retrieve the client assertion from the USIM using a claimed extension of the interface between the host part of the device and the cellular module. This can be achieved by introducing a new AT+ command or extending any other interface which is used instead of AT+ commands. The AF can apply the client assertion for JWT authentication with the AZF.

The USIM may calculate the client assertion using a client secret. The client secret may be shared between the USIM and the AZF using similar methods as in the above case of using the client secret for http basic authentication. Instead of using a symmetric key for calculation the client assertion, the USIM may use a private key, which is part of a private public key pair, for this purpose. In this case, instead of the shared key, the public key of the key pair is provisioned to the AZF.

In some embodiments, certificate based authentication is provided for the AF enabling the AF to authenticate with the AZF. For example, the USIM may comprise a private key and provide a signed X.509 certificate based on the private key. The apparatus performing the method of FIG. 2 may be configured to perform a mechanism, which allows the AF to receive the certificate as a TLS client certificate towards the AZF. In this case, the client id may be bound to the subject of the X.509 certificate.

In an embodiment, information and/or functionality related to client id and client secret, client assertions, or X.509 certificates may be outside the USIM. For example, such information and/or functionality may be stored in a separate applet on the same UICC iUICC, or eUICC.

The AF does not need to directly interact with the AZF to get an access token. The AF may be configured to retrieve or request the access token from the cellular module using an extension of the interface between a host part of the device comprising the AF and the cellular module. This can be achieved by introducing a new AT+ command or extending another interface which is used instead of AT+ commands. The AF may provide parameters, such as requested scopes, as input to the new interface. The AF may also include a direct request to the AZF in the input to the interface.

In this embodiment, interaction with USIM and AZF is performed by the cellular module. FIG. 6 illustrates an example of the cellular module (CM) performing in blocks 200, 210 and 220 on behalf of the AF. The AF sends to the CM an access token request 600, which may comprise parameters, such as requested scopes. In response to the access token request at 600, the CM, such as the ME, obtains the client credentials. This may include sending a request or command at 602 to the USIM, to retrieve client id and client secret, or client assertion from the USIM. Upon receiving the requested client credentials at 604 (such as the client id and the client secret, or the client assertion) from the USIM, the CM may send the access token request at 606, including the received client credentials and the parameters received from the AF, to the AZF. The CM receives the access token in an access token response at 608 from the AZF, and provides the access token to the AF in an access token response at 610. The AF may then send an API call at 612, comprising the access token from the CM, to the NEF API. Example embodiments illustrated above related to handling of client ids, client secrets, client assertions, and client certificates are applicable also to this embodiment.

In another example a client secret of the client credentials is based on an intermediate key generated based on a secret key of the SIM as part of an authentication and key agreement (AKA) procedure of the UE with the mobile network.

The client secret may thus be derived from the 5G key hierarchy, which is established during primary authentication. Update of the content of the USIM (by new client credentials for the AF) is thus not needed.

The USIM stores the same long-term secret key K that is stored in the ARPF. As defined in 3GPP TS 33.501, during applied AKA procedure, such as the EAP-AKA′ or 5G AKA, the USIM generates key material (CK, IK) from K that it forwards to the ME. The ME generates intermediate key K_{AUSF} based on the CK and IK from the USIM. In case of EAP-AKA′, K_{AUSF} is generated based on CK′ and IK′ derived from the CK and IK from the USIM. In some embodiments, the client secret is generated on the basis of the K_{AUSF}.

The client credentials transmitted in block 210 and received in block 300 may comprise, or are generated based on an application key and an application key identifier generated based on primary AKA of the UE (based on the secret key stored in the USIM). The UE, comprised by or connected to the apparatus performing the method of FIG. 2 may be configured to generate the intermediate key. The UE may further generate an application key and an application key identifier on the basis of the intermediate key. The UE may then provide the application key and an application key identifier for the AF.

The application key may be generated based on an intermediate key generated as part of or as a result of the primary AKA procedure of the UE to the mobile network. In some embodiments, the application key is generated on the basis of the K_{AUSF}. The application key may be generated on the basis of a FQDN of the AZF and a protocol identifier of a security protocol between the AF and the AZF.

In some embodiments, the AF and the AZF are configured to apply an authentication and key management for applications (AKMA) for the authorization to the NEF. On a high level, the AF is residing on the device and needs to authenticate with the AZF to get the access token. This authentication is executed using and extending the AKMA procedure.

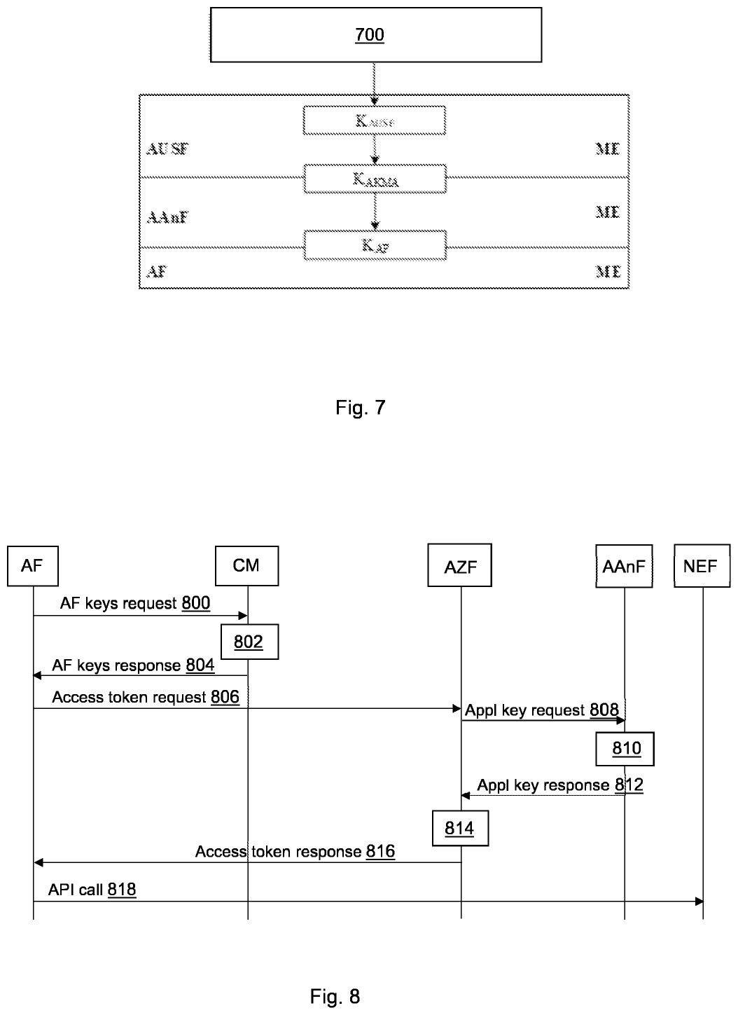

The application key may thus be an AKMA application key, which may also be denoted as K_{AF}. The application key identifier may be an AKMA key identifier (A-KID). With reference to FIG. 7, the ME may generate AKMA anchor key K_{AKMA} based on the K_{AUSF} obtained as a result of successful 5G primary authentication 700 of the UE. The A-KID may identify the K_{AKMA} key of the UE and A-KID may be generated based on the K_{AUSF}. The ME may generate the K_{AF} based on the K_{AKMA}.

With reference to FIG. 8, the AF sends an AF keys request 800, e.g. as a new command, to retrieve an application key K_{AF} and a key identifier A-KID from the CM.

An application identifier AF_ID may be an input parameter to generate the application key and the key identifier, e.g. as parameters in the command or request 800 from the AF to the CM. The application identifier may be based on a FQDN of the AZF and a protocol identifier of a security protocol between the AF and the AZF. The AF-ID may be set to the concatenation of the FQDN of the AZF and the protocol identifier. In another embodiment, the FQDN and the protocol identifier are provided to the CM not in form of the AF_ID but in the form of separate identifiers in the request 800.

The CM calculates 802 K_{AF}, using AF_ID (or FQDN of the AZF and the protocol identifier) and the K_{AKMA} as inputs to K_{AF} derivation function. The K_{AKMA} and the A-KID may be beforehand computed as part of the AKMA procedure based on the K_{AUSF} resulting from the primary authentication of the UE. The CM sends an AF keys response 804 including the K_{AF} and the A-KID.

The AF transmits to the AZF an access token request 806, comprising client credentials comprising or based on the K_{AF} and the A-KID as authentication information. In addition, the AF may provide parameters, such as requested scopes, as additional input to the access token request 806. For example, the AF may use http basic authentication and may set A-KID to a username field and K_{AF} to a password field. In another embodiment, the AF uses K_{AF} to calculate a client assertion. In the resulting JWT, either iss or sub claims or both claims can be set to A-KID. Alternatively, also a new claim in the JWT could be set to A-KID.

The AZF may be configured to send an application key request 808, such as an AKMA_ApplicationKey_Get_Request, to an AKMA anchor function (AAnF) in response to the access token request. The application key request 808 may comprise the application key identifier A-KID and the application identifier AF_ID of the requesting AF. If the access token request 806 includes A-KID, in authorization header (if http basic authentication is used) or as a claim in the client assertion, the AZF can invoke the AAnF of the mobile network by the request 808 to obtain K_{AF}. The AZF may also invoke the AAnF to provide a UE identifier. The application key request 808 to the AAnF may include A-KID received in the request 806 and the AF_ID.

The AAnf may generate 810 a reference application key based on the received AF_ID and associated K_{AKMA} (which has been computed as part of the AKMA procedure based on the K_{AUSF} resulting from the primary authentication of the UE). The reference application key should correspond to the K_{AF} generated by the ME (and could also be denoted as K_{AF′}). The AAnf may in block 810 also retrieve UE identifier, such as the subscription permanent identifier (SUPI) or the GPSI, associated with the received A-KID. The UE identifier may be stored together (as a triplet) with the A-KID and the K_{AKMA}. Such triplet may be stored in response to a register request from the AUSF as part of the AKMA procedure. The UE identifier may be stored in a database or another storage medium accessible by the AAnF. Such database may be referred to as AAnF Anchor Key database, for example.

The AZF receives an application key response 812 from the AAnF. The application key response comprises the reference application key. The application key response may also be extended to include the UE identifier.

The AZF authenticates 814 the requesting device (transmitting the request 806). This comprises verifying the received client credentials on the basis of comparing the application key in the received client credentials to the reference application key. Thus, the AZF may compare the reference application key received from the AAnF and the K_{AF} received in the access token request 806 (and initially generated by the CM). If they match, the client credentials are successfully verified (and the device authenticated). In such case the AF may be authorized and the access token generated for the AF, in block 814 or as a further block. The authorization may be associated with the UE identifier received from the AAnF.

The AZF may include the UE identifier in the access token response 816 comprising the access token to the AF. The UE identifier may be included in claims of the access token. The AZF may thus restrict the claims in the access token to the level of authority of the device identified by the UE identifier.

The AZF may comprise or access a cache comprising application key identifier(s) (A-KID), reference application key(s) (K_{AF′}), and associated UE identifier(s). The AZF may thus directly obtain the reference application key from the cache in response to the access token request 806 and based on the A-KID therein. In this case the AZF may need to contact the AAnF only if no entry for A-KID is in the cache or if the entry has expired (in agreement with finite life time of K_{AF}).

The AF may then send an access request message, such as an API call 818, comprising the received access token to the NEF API. The NEF API may authenticate the AF and allow or reject access to a mobile network service on the basis of the access token.

In another embodiment, the access token request of block 210 and 300 (e.g. the request 806) does not comprise the application key, but application key generation information, such as an assertion. The application key generation information may be obtained from the SIM or generated based on a secret key stored in the SIM. In this embodiment, the AZF may send to the AKMA anchor the application key request 808 comprising the application key identifier (A-KID) received in the access token request 806 (in block 300). The AZF may compute the application key (K_{AF}) based on the received application key generation information and compare the computed application key to a reference application key received from the AKMA anchor.

The AZF may be configured to determine whether the authentication information included in the access token request of block 210 and 300 refers to a client id or an A-KID, which the AZF can use to retrieve the client id or a UE identifier. For this purpose, the AF may be configured to include an indication of this (client id or A-KID being referred) into the access token request message. Such indication may be included, for example, in a field in the http header or in the body of an http message comprising the access request. If a client assertion is used, the indication could also be included in the JWT from the AF. For this purpose, the JWT can include a new claim, which can indicate that iss and/or sub claims should be interpreted as A-KID, or alternatively, the JWT can include a new A-KID claim, which directly includes the value of the A-KID.

The AF does not need to directly interact with the AZF to get an access token. The AF may be configured to retrieve or request the access token from the CM, for example by using an extension of the interface between a host part of the device comprising the AF and the CM. This can be achieved by introducing a new AT+ command or extending any other interface which is used instead of AT+ commands. The AF may provide parameters, such as requested scopes, as input to the new interface. The AF may also include a direct request to the AZF in the input to the interface.

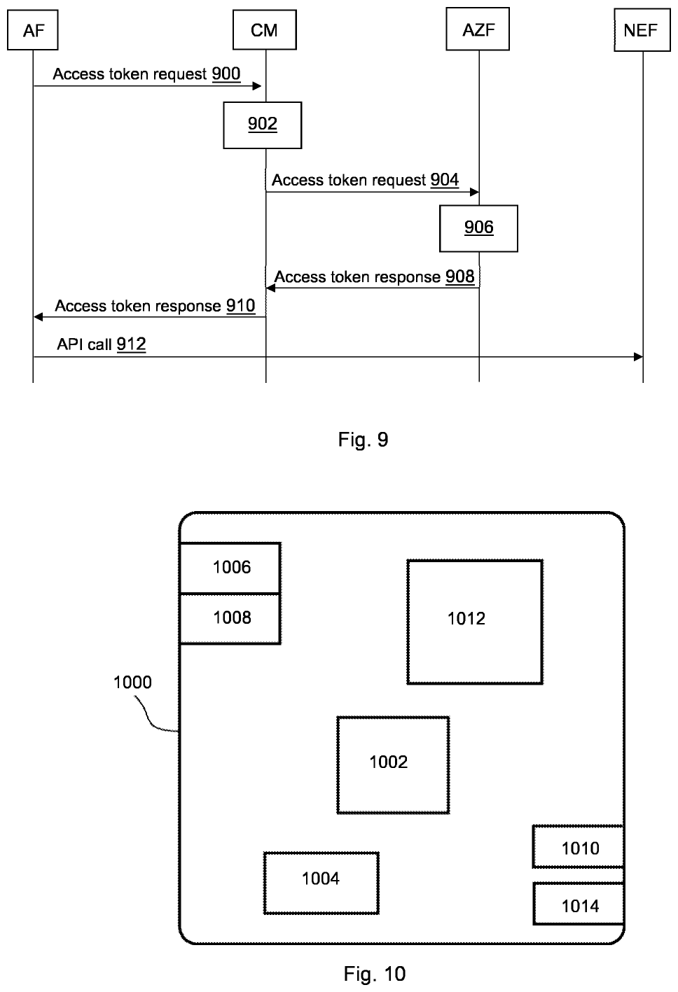

Interaction with USIM and AZF may thus be performed by the cellular module. FIG. 9 illustrates an example of the CM performing blocks 200, 210 and 220 on behalf of the AF. In response to an access token request 900 from the AF, the CM, such as the ME, obtains the client credentials, in the present embodiment by defining 902 the K_{AF} and the A-KID according to the AKMA procedure (and initially based on the USIM secret key K) as illustrated above. The CM may then send an access token request 904 to the AZF, including the client credentials and potential further parameters from the AF, such as requested scopes, to the AZF. The AZF may in block 906 perform operations (not shown) to perform authentication and authorization based on the received client credentials, and generate the access token in response to verification of the client credentials. In some embodiments, the AZF may in block 906 perform AKMA related features in co-operation with the AAnF as illustrated in connection with blocks 808 to 814. The AZF may then send the access token in an access token response 908 to the CM, which provides the access token to the AF in an access token response 910. The AF may then send an API call 912, comprising the access token from the CM, to the NEF API. Example embodiments illustrated above related to handling of K_{AF}, A-KID, client ids, client secrets, and client assertions, are applicable also to this embodiment.

While some embodiments have been described in the context of 3GPP 5G based systems, it should be thus appreciated that these or other embodiments of the invention may be applicable in connection with other technologies configured to operate on licensed or non-licensed band, such as 6G cellular systems, or other existing or future technologies comprising a NEF or an enhanced or advanced NEF with necessary modifications.

An electronic device comprising electronic circuitries may be an apparatus for realizing at least some embodiments of the present invention. The apparatus may be or may be comprised in a computer, a laptop, a tablet computer, a cellular phone, a machine to machine (M2M) device (e.g. an IoT sensor device or a vehicle communications unit for vehicle to anything (V2X) communications), an industrial network communications device a base station, access point device, a server, a network function element or node, or any other apparatus provided with suitable communication and processing capability. In another embodiment, the apparatus carrying out the above-described functionalities is comprised in such a device, e.g. the apparatus may comprise a circuitry, such as a chip, a chipset, a microcontroller, or a combination of such circuitries in any one of the above-described devices.

FIG. 10 illustrates an example apparatus capable of supporting at least some embodiments. Illustrated is a device 1000, which may comprise a communications device arranged to operate as the device 12 comprising the AF, or a device comprising the AZF, for example. The device may include one or more controllers configured to carry out operations in accordance with at least some of the embodiments illustrated above, such as some or more of the features illustrated above in connection with FIGS. 1 to 9. The device may be configured to operate as the apparatus configured to perform the method of FIG. 2 or FIG. 3, or embodiments thereof, for example.

Comprised in the device 1000 is a processor 1002, which may comprise, for example, a single-or multi-core processor wherein a single-core processor comprises one processing core and a multi-core processor comprises more than one processing core. The processor 1002 may comprise more than one processor. The processor may comprise at least one application-specific integrated circuit, ASIC. The processor may comprise at least one field-programmable gate array, FPGA. The processor may be means for performing method steps in the device. The processor may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The device 1000 may comprise memory 1004. The memory may comprise random-access memory and/or permanent memory. The memory may comprise at least one RAM chip. The memory may comprise solid-state, magnetic, optical and/or holographic memory, for example. The memory may be at least in part accessible to the processor 1002. The memory may be at least in part comprised in the processor 1002. The memory 1004 may be means for storing information. The memory may comprise computer instructions that the processor is configured to execute. When computer instructions configured to cause the processor to perform certain actions are stored in the memory, and the device in overall is configured to run under the direction of the processor using computer instructions from the memory, the processor and/or its at least one processing core may be considered to be configured to perform said certain actions. The memory may be at least in part comprised in the processor. The memory may be at least in part external to the device 1000 but accessible to the device. For example, control parameters affecting controlling operations illustrated in connection with FIG. 2 or FIG. 3 may be stored in one or more portions of the memory and used to control operation of the apparatus. Further, the memory may comprise other control parameters, for example.

The device 1000 may comprise a transmitter 1006. The device may comprise a receiver 1008. The transmitter and the receiver may be configured to transmit and receive, respectively, information in accordance with at least one wired or wireless, cellular or non-cellular standard. The transmitter may comprise more than one transmitter. The receiver may comprise more than one receiver. The transmitter and/or receiver may be configured to operate in accordance with global system for mobile communication, GSM, wideband code division multiple access, WCDMA, long term evolution, LTE, 5G or other cellular communications systems, WLAN, and/or Ethernet standards, for example. The device 1000 may comprise a near-field communication, NFC, transceiver 1010. The NFC transceiver may support at least one NFC technology, such as NFC, Bluetooth, Wibree or similar technologies.

The device 1000 may comprise user interface, UI, 1012. The UI may comprise or be connected to at least one of a display, a keyboard, a touchscreen, a speaker, and a microphone. A user may be able to operate the device via the UI, for example to for example to configure operating parameters stored in the memory 1004, such as parameter affecting an operation of the above described method or an embodiment thereof.

Depending on the type or use of the device 1000, it may comprise or be arranged to accept a user identity module or other type of memory module 1014. The user identity module may comprise, for example, a SIM, USIM, and/or a personal identification IC card installable in the device 1000.

The processor 1002 may be furnished with a transmitter arranged to output information from the processor, via electrical leads internal to the device 1000, to other devices comprised in the device. Such a transmitter may comprise a serial bus transmitter arranged to, for example, output information via at least one electrical lead to memory 1004 for storage therein. Alternatively to a serial bus, the transmitter may comprise a parallel bus transmitter. Likewise the processor may comprise a receiver arranged to receive information in the processor, via electrical leads internal to the device 1000, from other devices comprised in the device 1000. Such a receiver may comprise a serial bus receiver arranged to, for example, receive information via at least one electrical lead from the receiver 1008 for processing in the processor. Alternatively to a serial bus, the receiver may comprise a parallel bus receiver.

The device 1000 may comprise further devices not illustrated in FIG. 10, such as further transmitter(s) and receiver(s) or UI elements. The processor 1002, the memory 1004, the transmitter 1006, the receiver 1008, the NFC transceiver 1010, the UI 1012 and/or the user identity module 1014 may be interconnected by electrical leads internal to the device 1000 in a multitude of different ways. For example, each of the aforementioned devices may be separately connected to a master bus internal to the device, to allow for the devices to exchange information. However, as the skilled person will appreciate, this is only one example and depending on the embodiment various ways of interconnecting at least two of the aforementioned devices may be selected.

While the forgoing examples are illustrative of the principles of the present invention in one or more particular applications, it will be apparent to those of ordinary skill in the art that numerous modifications in form, usage and details of implementation can be made without departing from the principles and concepts of the invention as defined by the claims set forth below. It should also be understood that terminology employed herein is used for the purpose of describing particular embodiments only and is not intended to be limiting.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

1. An apparatus, comprising one or more processors and memory comprising instructions, when executed by the one or more processors, cause the apparatus to perform at least the following:
obtaining client credentials associated with a subscriber identity module of a user equipment, characterized by
sending, to an authorization function, an access token request for an access token to authorize, for an application function outside a mobile network, access to a network exposure function of the mobile network, wherein the access token request comprises the client credentials,
receiving the access token issued by the authorization function, and
sending an access request to the network exposure function to access a service of the mobile network via the network exposure function, wherein the access request comprises the received access token.

2. The apparatus of claim 1, wherein
the subscriber identity module is configured to store at least a portion of the client credentials and the apparatus is configured to receive the at least a portion of client credentials from the subscriber identity module, or
a client secret of the client credentials is based on an intermediate key generated based on a secret key of the subscriber identity module as part of an authentication and key agreement procedure of the user equipment with the mobile network.

3. The apparatus of claim 2, wherein the user equipment is comprised by or connected to the apparatus and configured to:
generate an application key and an application key identifier on the basis of the intermediate key, and
provide the application key and an application key identifier for the application function, wherein the client credentials comprise or are generated based on the application key and the application key identifier.

4. The apparatus of claim 1, wherein the apparatus is configured to perform the application function which is configured to send the access request and:
send a request for client credentials to the subscriber identity module or to the user equipment comprising the subscriber identity module, and
receive the client credentials from the subscriber identity module or the user equipment and include the received client credentials in the access token request.

5. The apparatus of claim 1, wherein the apparatus is configured to perform the application function which is configured to send the access request and:
send a request for an access token to the user equipment comprising the subscriber identity module, and
receive the access token from the user equipment after the user equipment has sent the access token request and received the access token on behalf of the application function.

6. The apparatus of claim 5, wherein the user equipment comprises a cellular module configured to:
in response to a request for an access token from the application function, retrieve at least a portion of the client credentials from the subscriber identity module or generate at least a portion of the client credentials,
send the access token request comprising the client credentials to the authorization function,
receive the access token from the authorization function in response to verification of the client credentials by the authorization function, and
provide the access token to the application function, wherein the application function is configured to include the access token received from the cellular module in the access request to the network exposure function.

7. An apparatus, comprising one or more processors and memory comprising instructions, when executed by the one or more processors, cause the apparatus to perform:
receiving, by an authorization function, an access token request, characterized in that the access token request is for an access token to authorize, for an application function outside a mobile network, access to a network exposure function of the mobile network, wherein the access token request comprises client credentials associated with a subscriber identity module of a user equipment,
authorizing the access for the application function and generating the access token in response to verification of the client credentials, and
sending the access token to authorize the access to the network exposure function for the application function.

8. The apparatus of claim 7, wherein the apparatus is configured to
receive the access token request from the application function, or from a user equipment or cellular module sending the access token request on behalf of the application function, and
send the access token in an access token response to the application function, the user equipment, or the cellular module in response to the verification of the client credentials.

9. The apparatus of claim 7, wherein the client credentials comprise an application key and an application key identifier based on an intermediate key based on an authentication and key agreement procedure of the user equipment with the mobile network, and the apparatus is configured to
send an application key request, comprising the application key identifier and an application identifier, to an authentication and key management for applications, AKMA, anchor function,
receive an application key response from the AKMA anchor function, wherein the application key response comprises a user equipment identifier and a reference application key computed by the AKMA anchor on the basis of the application key identifier and the application identifier,
verify the client credentials on the basis of comparing the application key in the received client credentials to the reference application key, and
include the user equipment identifier in claims of the access token.

10. The apparatus of claim 1, wherein the client credentials comprise: a client secret associated with a client identifier, a signed certificate, or a client assertion, such as a javascript object notation web token, computed based on a client secret.

11. The apparatus of claim 1, wherein the application function is an industrial network controller and the user equipment comprises or is a programmable logic controller and the access request is sent to control a mobile connectivity configuration of an industrial network.

12. A method for an apparatus, comprising:
obtaining client credentials associated with a subscriber identity module of a user equipment, characterized by
sending, to an authorization function, an access token request for an access token to authorize, for an application function outside a mobile network, access to a network exposure function of the mobile network, wherein the access token request comprises the client credentials,
receiving the access token issued by the authorization function, and
sending an access request to the network exposure function to access a service of the mobile network via the network exposure function, wherein the access request comprises the received access token.

13. The method of claim 12, wherein
the subscriber identity module is configured to store at least a portion of the client credentials and the at least a portion of client credentials is received from the subscriber identity module, or
a client secret of the client credentials is based on an intermediate key generated based on a secret key of the subscriber identity module as part of an authentication and key agreement procedure of the user equipment with the mobile network.

14. A method for an authorization function, comprising:
receiving an access token request, characterized in that the access token request is for an access token to authorize, for an application function outside a mobile network, an access to a network exposure function of the mobile network, wherein the access token request comprises client credentials associated with a subscriber identity module of a user equipment,
authorizing the access for the application function and generating the access token in response to verification of the client credentials, and
sending the access token to authorize the access to the network exposure function for the application function.

15. A non-transitory computer readable medium, comprising instructions for causing a data processing apparatus to perform the method of claim 12.

16. A non-transitory computer readable medium, comprising instructions for causing a data processing apparatus to perform the method of claim 14.
